(19) United States
(12) Patent Application Publication
(10) Pub. No.: US 2014/0013429 A1
(43) Pub. Date: Jan. 9, 2014

(54) METHOD FOR PROCESSING AN OPERATING APPLICATION PROGRAM AND DEVICE FOR THE SAME

(71) Applicant: Tencent Technology (SHENZHEN) Company Limited, Shenzhen City (CN)

(72) Inventor: Zhaohua Lu, Shenzhen (CN)

(73) Assignee: Tencent Technology (SHENZHEN) Company Limited, Shenzhen City (CN)

(21) Appl. No.: 14/022,017

(22) Filed: Sep. 9, 2013

Related U.S. Application Data
(63) Continuation of application No. PCT/CN2012/085579, filed on Nov. 29, 2012.

(30) Foreign Application Priority Data
Nov. 29, 2011 (CN) 201110387409.X

(51) Int. Cl. G06F 21/56

(52) U.S. Cl. CPC G06F 21/56
USPC 726/22

(57) ABSTRACT

A method for processing an operating application program and device for the same is disclosed in the embodiment of the present disclosure. The method includes following steps: a step of determining a target system call of a target application program when the target application program is initiated, a step of suspending the target system call when receiving a parameter of the target application program and a step of stopping or continuing the target system call in accordance with the parameter. The device includes a determining module, a suspending module and a processing module. The embodiment of the present disclosure can stop the action before the suspected action is executed without terminating the execution of the application program. Such a method can carry out instantaneous monitor and wide ranging applicability, that it is widely used in monitoring the suspected application program and protecting the sensitive application program.

### CROSS REFERENCE TO RELATED APPLICATION

This application is a continuation of International Application No. PCT/CN2012/085579, filed on Nov. 29, 2012. This application claims the benefit and priority of Chinese Application No. 201110387409.X, filed on Nov. 29, 2011. The entire disclosure of each of the above applications is incorporated herein by reference.

### FIELD OF THE INVENTION

The present invention relates to a field of mobile terminals, and more particularly relates to a method for processing an operating application program and device for the same.

### BACKGROUND OF THE INVENTION

With the increasing of the development of mobile terminals, as the competition of vendors and popularity of mobile terminal usage, occurrences of Internet viruses, Trojans, and various malicious programs have been discovered therein. Therefore, anti-virus vendors have accordingly introduced anti-virus software for the smart terminals. Taking Network-monitoring as an example, a practical approach of the mobile terminal security software is to intercept or inquire to intercept when suspected application program is detected connecting to a network, and the interception method is to terminate the task of the networking program.

After analyzing the prior arts, the inventors have found that there are some drawbacks in the prior arts. Conventionally, when inquiring for intercepting, the suspected software still can connect to a network. If the terminal user determines to intercept after a very long period of time, the suspected software may have been used a lot of network traffic which is exceed the expectation of the terminal user or operate an illegal action by implementing the Internet or charge some fee from the terminal user. Generally, the interception method is to terminate the program. However, the terminal user may be still interested in other parts of the suspected software. This simple approach to end the program may cause inconvenience to the end user.

### SUMMARY OF THE INVENTION

A method for processing an operating application program and device for the same is disclosed in the embodiment of the present disclosure. The method includes the following steps. A step of determining a predetermined suspected program or any application program to be a target application program; a step of determining a target system call of the target application program when the target application program is initiated; a step of suspending the target system call when receiving a parameter of the target application program; and a step of judging if the parameter is a predetermined suspected parameter; if yes, then stopping the target system call; if no, then continuing the target system call.

A method for processing an operating application program includes the following steps. A step of determining a target system call of a target application program when the target application program is initiated; a step of suspending the target system call when receiving a parameter of the target application program; and a step of stopping or continuing the target system call in accordance with the parameter.

A device for processing an operating application program includes a determining module, a suspending module and a processing module. The determining module is configured for determining a target system call of a target application program when the target application program is initiated. The suspending module is configured for suspending the target system call when receiving a parameter of the target system call. The processing module configured for stopping or continuing the target system call in accordance with the parameter.

A method for processing an operating application program and device for the same is disclosed in the embodiment of the present disclosure. When the target application program is initiated, a target system call of a target application program is determined; when receiving a parameter of the target application program, the target system call is suspended; the target system call is stopped or continued in accordance with the parameter. The method provided in the embodiment can stop an operation before the suspected operation is executed without terminating the execution of the application program. Such a method can carry out instantaneous monitor and wide ranging applicability, that it is widely used in monitoring the suspected application program and protecting the sensitive application program.

### DESCRIPTION OF THE DRAWINGS

The foregoing summary, preferred embodiments, and other aspects of subject matter of the present disclosure will be best understood with reference to a detailed description of specific embodiments, which follows, when read in conjunction with the accompanying drawing, in which:

FIG. 1 is a flow chart illustrating a method for processing an operating application program provided in one embodiment of the present disclosure;

FIG. 2 is a flow chart illustrating a method for processing an operating application program provided in one embodiment of the present disclosure;

FIG. 3 is a flow chart illustrating a method for processing an operating application program in the present disclosure is implemented to prevent the privacy being stolen; and

FIG. 4 is a structural view illustrating a device for processing an operating application program in the embodiment of the present disclosure.

### DETAILED DESCRIPTION OF THE PREFERRED EMBODIMENTS

The above-mentioned description of the present disclosure can be best understood by referring to the following detailed description of the preferred embodiments and the accompanying drawings.

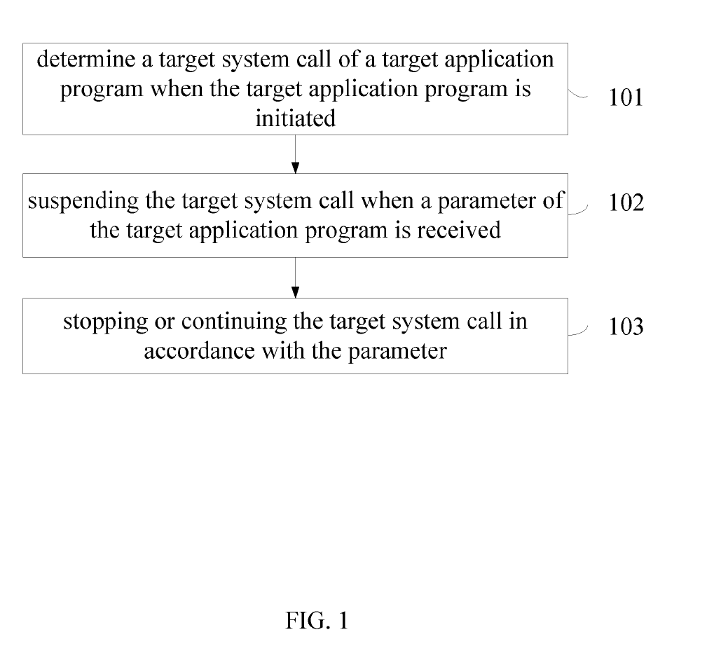

FIG. 1 is a flow chart illustrating a method for processing an operating application program provided in one embodiment of the present disclosure. The operating main body in the embodiment is a mobile terminal and practically, the mobile terminal is a mobile phone, a tablet and so on. As shown in FIG. 1, the embodiment includes the following steps. In step 101, it is to determine a target system call of a target application program when the target application program is initiated. In step 102, it is to suspend the target system call when receiving a parameter of the target application program. In step 103, it is to stop or continue the target system call in accordance with the parameter.

Alternatively, the step 103 of stopping or continuing the target system call includes the following steps: A step of judging if the parameter is a predetermined suspected parameter; if yes, then the target system call is stopped; if no, then the target system call is continued or a step of reporting the parameter to a terminal user, when receiving an agreeing command from the terminal user, the target system call is continued, when receiving a forbidding command from the terminal user, the target system call is stopped.

Alternatively, before the step 101 of determining the target system call of the target application program when the target application program is initiated, the method includes a step of determining a predetermined suspected program or any application program to be the target application program.

Alternatively, the step of determining a predetermined suspected program or any application program to be the target application program includes steps of: analyzing the parameter of the target system call of the application program when installing the application program and determining the application program with the parameter having an operation authorization to call private information or a private event to be the target application program. The private event includes an initiation of at least one of calling a camera, calling a GPS module, calling a base station positioning user location function, turning on a three-way calling, making a phone call, receiving a phone call, turning on a phone recorder, accessing an address book, accessing a calling history, accessing an SMS (short message service) message history, intercepting an SMS message, executing silent installation of other programs, automatically connecting data transfer or turning on the phone to initiate at least one thereof, and the private information includes at least one of contact information, communication information, photo information or video information.

Alternatively, the step of determining a target system call of the target application program when the target application program is initiated includes a step of judging if the target application program includes any one of predetermined calls when the target application program is initiated; if yes, then determining the predetermined call in the target application program as the target system call.

When a function of the target system call is to send an SMS message, the parameter is an SMS message content or a target phone number. When the function of the target system call is to connect to a network for the target application program, the parameter is information of a target network to be connected. When the function of the target system call is to modify the target application program, the parameter is modifying information from an operator or from a terminal user.

The method provided in the embodiment is to stop a suspected action before the suspected action is executed without terminating the execution of the application program. Such a method can carry out instantaneous monitoring and wide-ranging applicability, that it is widely used in monitoring the suspected application program and protecting the sensitive application program.

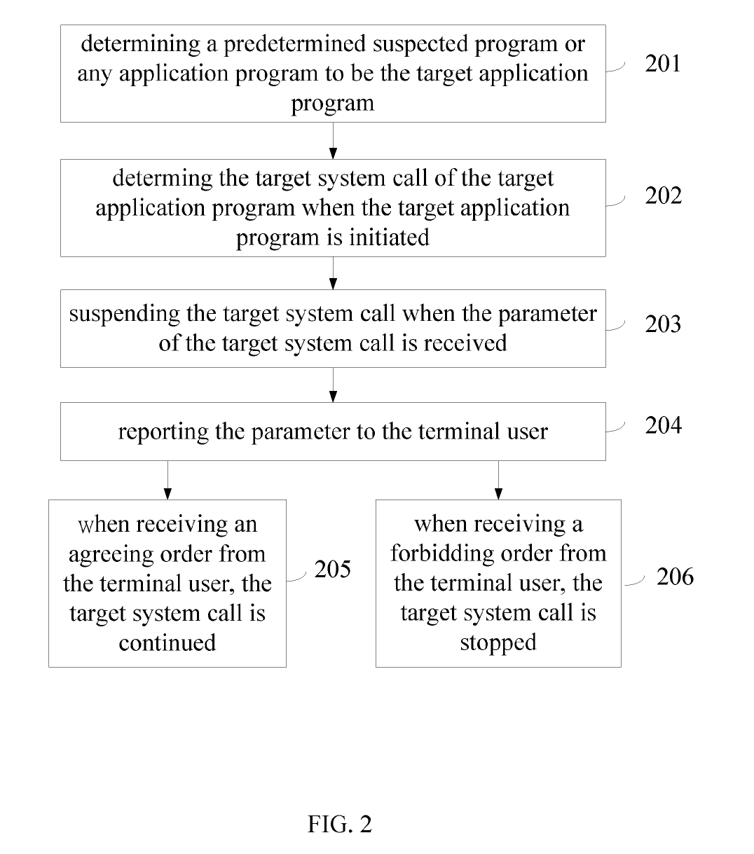

FIG. 2 is a flow chart illustrating a method for processing an operating application program provided in one embodiment of the present disclosure. The operating main body in the embodiment is a mobile terminal and practically, the mobile terminal is a mobile phone, a tablet and so on. As shown in FIG. 2, the embodiment includes the following steps.

In step 201, it is to determine a predetermined suspected program or any application program to be the target application program. The predetermined suspected program is assumed to be a terminal application program, which is capable of causing an unexpected effect or a suspected action (such as call private information or a private event). These actions (including a private event) include, but not limited to: no hints, non-specific properties of software (declare or suggest) and a sending an SMS message deduction, which the user does not desire to happen, sending a Bluetooth message, deleting some documents, calling a camera, calling a GPS (Global Positioning System) module, calling a base station positioning user location function, turning on a three-way calling, making a phone call, receiving a phone call, turning on a phone recorder, accessing an address book, accessing a calling history, accessing an SMS message history, intercepting an SMS message, performing silent installation or uninstallation to other programs, performing automatic network connection to transfer data or performing power-on Autorun and so on. The private information includes, but not limited to, contact information, communication information, photo information or video information. The predetermined suspected program is preinstalled by a technical staff or installing or modifying by the mobile terminal user and it is not limited in the embodiment of the present disclosure.

Certainly, when the application program is being installed, the parameter of the target system call of the application program is analyzed and the parameter with operation authorization relating to the private information or the private event described above is determined to be the predetermined suspected program.

Because those smart terminals, such as Android and Symbian system, can flash ROM (Read-Only Memory) due to the factors of the factory owners, merchants, sellers or buyers, some of those ROMs may include a system program (or a fake system program) with suspected actions. Under this condition, an interception is required for any application program. Therefore, any application program in the mobile terminal is required to be monitored and the programs, which have been initiated or are being initiated, are required to be intercepted.

It should be noted that, for a mobile terminal, it is possible to determine one or more target application programs and subsequent steps are executed for the determined target application programs, respectively.

In step 202, when the target application program is initiated, the target system call of the target application program is determined When the target application program is initiated, it is to determine if the target application program includes any predetermined call in accordance with the predetermined calls of the mobile terminal. If yes, then the predetermined call included in the target application program is determined as the target system call. The predetermined calls are setup by technical staffs. A person with ordinary skilled in the art should understand that each of the calls includes different functions and the predetermined calls are the calls with the functions causing unpredictable bad effects or suspected actions. The actions include, but not limited thereto, no hints, some properties of the action not belong to the software (declare or suggest), such as a sending SMS message expense, using Internet, sending Bluetooth information, deleting some documents, executing silent uninstallation of programs, accessing user's address book, accessing user's storage information and so on.

In step 203, when receiving the parameter of the target system call, the target system call is suspended. When the mobile terminal receives the parameter of the target system call, it means that the target system call is going to be initiated and the target system application is needed to be suspended. Therefore, when the monitoring target system call is initiated, the target system call is suspended. Practically, when the function of the target system call is to send an SMS message, the parameter is an SMS message content or a target phone number, a viral SMS message content or any target phone numbers, which can cause the mobile terminal sending illegal contents or some extra charging for the user. When the function of the target system call is to connect to a network for the target system application, the parameter is the information to connect to the target network. When the connecting target network is a cmwrap network or some other pay networks, the mobile terminal would be charged some money. When the function of the target system call is to modify the target application program, the parameter is modifying information from the operator or from the terminal user. When the target application program is maliciously modified, the target application program may be crashed and the normal usage of the user may be affected.

In step 204, the parameter is reported to the terminal user. The parameter is reported to the terminal user and the user can determine continuing or forbidding the target system call in accordance with the parameter. In the practical situation, when the parameter is reported to the terminal user, the parameter is processed to determine a practical action corresponding to the parameter. The corresponding relationship between the parameter and the practical actions is known by the mobile terminal, and the practical action corresponding to the parameter is reported to the terminal user. Alternatively, the mobile terminal can provide an interface with options for the terminal user and the interface at least includes an agreeing option and a forbidding option. When the terminal user chooses to continue the target system call, the agreeing option is checked. When the terminal user chooses to suspend the target system call, the forbidding option is checked.

In step 205, when the terminal user decides to continue the target system call, the target system call is continued. When the terminal user considers that the parameter or the practical action of the target system call is not a suspected action or the terminal user is interested in the target system call, the terminal user decides to continue the target system call and the suspension of the target system call is cancelled and the target system call is continued.

In step 206, when the terminal user chooses to suspend the target system call, the target system call is suspended. When the terminal user considers that the parameter of the practical action of the target system call is a suspected action or the terminal user is not interested in the target system call, the terminal user chooses to stop the target system call and the suspension of the target system call is cancelled and the target system call is stopped.

In another embodiment, the steps 203-206 can be replaced by the following steps: judging if the parameter is a predetermined suspected parameter; if yes, then the target system call is stopped; if no, then the target system call is continued. In the embodiment, the determination of the parameter by the terminal user is not included and the predetermined suspected parameter is implemented in the parameter of the target system call. A reference value or reference value range for determining whether the predetermined suspected parameter is a suspected action is set up by the technical staffs.

In the practical situation, the previous steps 203-206 are to include the predetermined function in the dynamic library of the system call and replace the pointer address of the target system call. The predetermined function includes the functionalities of steps 203-206. Practically, after the target system call is determined, the predetermined function is inputted into the target application program. The predetermined function is consistent with the function signature and the calling convention of the target system call. When the function of the target system call is received, the Import Address Table (IAT) of the target application program is modified through the Application Programming Interface (API) Hook, the pointer address of the target system call is replaced by the address inputted by the predetermined function. To input the predetermined functions in the target application program, different methods can be used in accordance with different operating systems. For example, Android system implements the ptrace function and Symbian system implements logic drive device program. The API Hook is a method to replace (hook or input) the system call to be customized call. The function signature is an order of the parameter data types and returned data type in the data type of the parameter of the function. The calling convention is the rule how the function transfers the parameter and the returned result.

The method provided in the present disclosure is to stop the action before the suspected action is initiated without terminating the execution of the application program. Such a method can carry out instantaneous monitor and wide ranging applicability, that it is widely used in monitoring the suspected application program and protecting the terminal (cell phone) software, which is probably being attacked by the suspected software. The suspected software includes, but is not limited herein, system software and competitor program. These attack actions are, but are not limited herein, forbidding the target software using Internet, forbidding sending a message, terminating an operation, deleting, uninstalling, limiting accessing a system resource and so on. Furthermore, the API Hook is implemented herein to intercept the suspected software before other surveillance systems, which don't have the process in the present disclosure and can intercept the actions, such as terminating task, deleting, uninstalling, sending an SMS message by low level of API and so on.

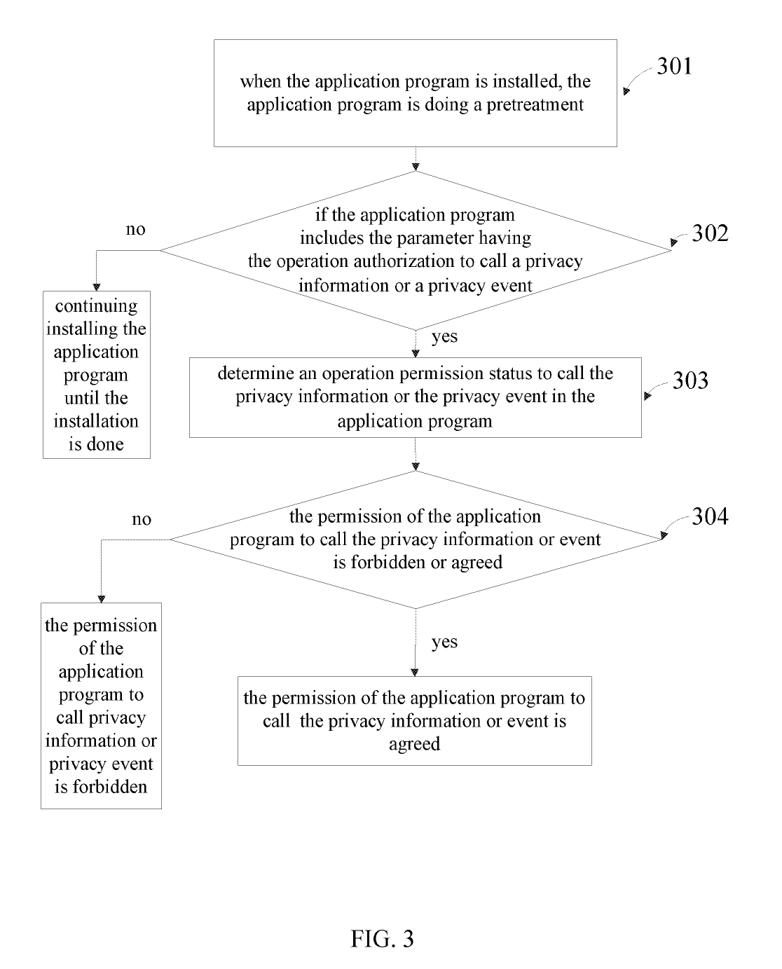

FIG. 3 is a flow chart illustrating a method for processing an operating application program in the present disclosure is implemented to prevent the privacy being stolen. The method for processing an operating application program in the present disclosure is well implemented to prevent the privacy being stolen. The private information and the private event are described as the previous description. The method for processing an operating application program in the embodiment of the present disclosure includes the following steps. In step 301, when the application program is installed, the application program is doing a pretreatment. The application doing a pretreatment is, but is not limited herein, to do a virus scanning in the application program. Practically, the virus scanning process in the application program is that the application program is compared to a characteristic within a malicious program database. When the application program is matched to the characteristic in the malicious program database, the application program is notified as the malicious program and warns the user to terminate installing the application program, stop installing the application program and the operation is ended. When the application program is matched to the characteristic in the malicious program database, it is going to step 302.

In step 302, the parameter of the target system call of the application program is analyzed, and it is to determine if the application program includes the parameter having the operation authorization to call the private information or the private event. When the application program includes the parameter having the operation authorization to call the private information or the private event, it is going to Step 303. When the application program doesn't include the parameter having the operation authorization to call the private information or the private event, the installation of the application program is continued until the installation of the application program is done. Practically, the parameter of the operation authorization of the application program is analyzed to determine if the application program includes the parameter having the operation authorization to call the private information or the private event. An operation authorization table of the application program is obtained. The operation authorization table of the application program is analyzed and the application program is determined to include the parameter having the operation authorization to call the private information or the private event when the operation authorization to call the private information or the private event is existed in the operation authorization table.

In step 303, it is to determine an operation permission status to call the private information or the private event in the application program. The operation permission of the private information or the private event includes forbidding or agreeing. Practically, the operation permission status to call the private information or the private event in the application program includes the following steps. An anti-privacy-stealing installation mode is provided for the user and the anti-privacy-stealing provides the operation permission status of the private information or the private event for the user to choose the operation permission status of the private information or the private event. The operation permission status of the private information or the private event given by the user is received and saved.

The operation procedure of the step is practically executed as the following. The parameter of the target system call of the application program is analyzed. When the parameter to call the private information or the private event is found in the application program, asking information is sent to the user. The asking information is to notify the user that the application program includes the operation authorization to call the private information or the private event and ask the user if the operation authorization to call the private information or the private event is required to setup. At the same time, the anti-privacy-stealing mode of the operation permission status of the private information or the private event is provided for the user and the default mode of the anti-privacy-stealing mode is to forbid the operation permission status to provide the private information or the private event. The user can cancel or partially cancel the forbidding status of the anti-privacy-stealing mode to provide the operation permission status of the private information or the private event. The operation permission status is changed from the forbidding status of the operation permission status to be the agreeing status. The chosen operation permission status of the private information or the private event given by the user is received and saved. The installation of the application program is continued until the installation of the application program is done.

In step 304, when the application program is operating, the permission of the application program to call the private information or the private event is forbidden or granted in accordance with the operation permission status. If the operation permission status is a forbidding status, it is to stop the application program to call the private information or the private event. Of course, the terminal user has higher priority to decide if the calling procedure is executed. If the operation permission status is an agreeing status, the permission of the application program to call the private information or the private event is granted. Moreover, it should be noted that the saved operation permission status of the application program to call the private information or the private event can be modified.

When the application program is being installed, the operation authorization of the application program is analyzed to determine if the application program includes the parameter to call the private information or the private event. When the application program includes the parameter to call the private information or the private event, the operation permission status of the private information or the private event is determined. When the application program is operating, the permission of the application to call the private information or the private event is determined in accordance with the operation authorization status or the terminal user. The stealing action of the privacy by the application program is automatically defended to overcome the drawback of the scanning defense that the privacy stealing malicious program is not detected. In addition, the technical solution can determine the operation authorization status of the private information or the private event when the application program is being installed. The determination method is by a way of package or a dummy and the user is not required to have a certain professional technology to reduce the difficulty of the user operation.

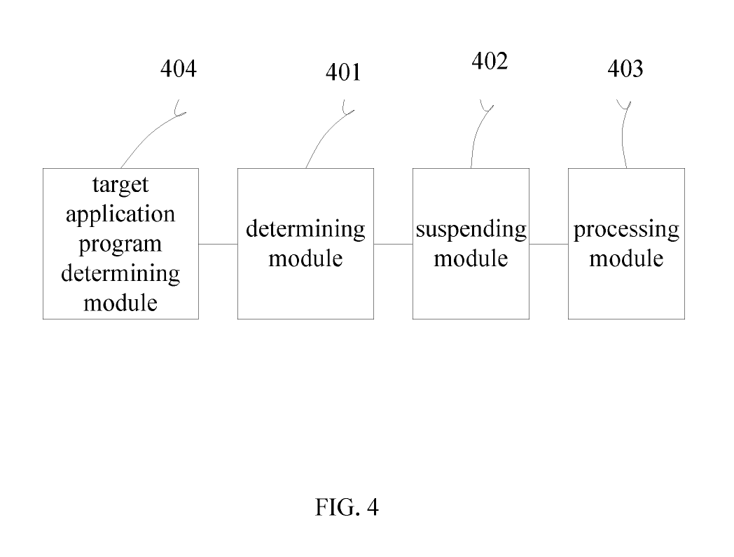

FIG. 4 is a structural view illustrating a device for processing the application program in the embodiment of the present disclosure. As shown in FIG. 4, the device includes a determining module 401, a suspending module 402 and a processing module 403. The determining module 401 is configured for determining the target system call of the target application program when the target application program is operating. The suspending module 402 is configured for suspending the target system call when the parameter of the target system call is received. The processing module 403 is configured for stopping or continuing the target system call in accordance with the parameter. The processing module 403 includes a first processing unit and a second processing unit. The first processing unit is configured for judging if the parameter is a predetermined suspected parameter; if yes, then stopping the target system call; if no, then continuing the target system call. The second processing unit is configured for reporting the parameter to a terminal user, when receiving an agreeing command from the terminal user, continuing the target system call, when receiving a forbidding command from the terminal user, stopping the target system call. Alternatively, the device further includes a target application program determining module 404. The target application program determining module 404 is configured for determining a predetermined suspected program or any application program to be the target application program. Alternatively, the target application program determining module 404 is practically configured for analyzing the parameter of the target system call of the application software and determining the application program with the parameter to call the private information or the private event to be the target application program when the application program is being installed.

The private event includes calling a camera, calling a GPS module, calling a base station positioning user location function, turning on three-way calling, making a phone call, receiving a phone call, turning on a phone recorder, accessing an address book, accessing a calling history, accessing an SMS message history, intercepting an SMS message, executing silent installation of other programs, automatically network connection data transfer or turning on the phone to initiate at least one thereof, and the private information includes at least one of contact information, communication information, photo information or video information.

Alternatively, the determining module 401 is practically configured for judging if the target application program includes any predetermined call; if yes, then the target application program with the predetermined call is determined to be the target system call. When a function of the target system call is to send an SMS message, the parameter is an SMS message content or a target phone number. When the function of the target system call is to connect to a network for the target application program, the parameter is information of a target network to be connected. When the function of the target system call is to modify the target application program, the parameter is modifying information from an operator or from a terminal user.

The device provided in the present disclosure and the method in the embodiment are the same concept and the practical process procedure is disclosed in the method embodiment and the detail description of the device is omitted herein.

The person with ordinary skill in the art understood that all or part of the steps of the embodiments may be accomplished by the hardware and also can be achieved in accordance with the hardware controlled by the software. The steps can be stored in a readable storage medium of a calculator and the storage medium can be a read only storage medium, a disc drive or an optical drive.

As described above, the present disclosure has been described with preferred embodiments thereof and it is understood that many changes and modifications to the described embodiments can be carried out without departing from the scope and the spirit of the invention that is intended to be limited only by the appended claims.

What is claimed is:

1. A method for processing an operating application program, comprising:
determining a predetermined suspected program or any application program to be a target application program;
determining a target system call of the target application program when the target application program is initiated;
suspending the target system call when receiving a parameter of the target application program; and
judging if the parameter is a predetermined suspected parameter; if yes, then stopping the target system call; if no, then continuing the target system call.

2. A method for processing an operating application program, comprising:
determining a target system call of a target application program when the target application program is initiated;
suspending the target system call when receiving a parameter of the target application program; and
stopping or continuing the target system call in accordance with the parameter.

3. The method according to claim 2, wherein the step of stopping or continuing the target system call comprises:
judging if the parameter is a predetermined suspected parameter; if yes, then stopping the target system call; if no, then continuing the target system call.

4. The method according to claim 2, wherein the step of stopping or continuing the target system call comprises:
judging if the parameter is a predetermined suspected parameter; if yes, then reporting the parameter to a terminal user, when the terminal user decides continuing the target system call, the target system call is continued, when the terminal user decides to stop the target system call, the target system call is stopped.

5. The method according to claim 2, wherein before the step of determining the target system call of the target application program when the target application program is initiated comprises:
determining a predetermined suspected program or any application program to be the target application program.

6. The method according to claim 5, wherein the step of determining a predetermined suspected program or any application program to be the target application program comprises:
when installing the application program, analyzing the parameter of the target system call of the application program and determining the application program with the parameter having an operation authorization to call private information or a private event to be the target application program.

7. The method according to claim 6, wherein the private event comprises calling a camera, calling a GPS module, calling a base station positioning user location function, turning on a three-way calling, making a phone call, receiving a phone call, turning on a phone recorder, accessing an address book, accessing a calling history, accessing an SMS message history, intercepting an SMS message, executing silent installation of other programs, automatically transferring network connection data or executing a power-on Autorun; and
the private information comprises at least one of contact information, communication information, photo information or video information.

8. The method according to claim 2, wherein the step of determining a target system call of the target application program when the target application program is initiated comprises:
judging if the target application program comprises any one of predetermined calls when the target application program is initiated; if yes, determining the predetermined call in the target application program as the target system call.

9. The method according to claim 2, wherein when a function of the target system call is to send an SMS message, the parameter is an SMS message content or a target phone number;
when the function of the target system call is to connect to a network for the target application program, the parameter is information of a target network to be connected;
when the function of the target system call is to modify the target application program, the parameter is modifying information from an operator or a terminal user.

10. A device for processing an operating application program, comprising:
a determining module configured for determining a target system call of a target application program when the target application program is initiated;
a suspending module configured for suspending the target system call when receiving a parameter of the target system call; and
a processing module configured for stopping or continuing the target system call in accordance with the parameter.

11. The device according to claim 10, wherein the processing module comprises:
a first processing unit configured for judging if the parameter is a predetermined suspected parameter; if yes, then stopping the target system call; if no, then continuing the target system call; and
a second processing unit configured for reporting the parameter to a terminal user, when receiving an agreeing command from the terminal user, continuing the target system call, when receiving a forbidding command from the terminal user, stopping the target system call.

12. The device according to claim 10, wherein the device further comprises:
a target application program determining module configured for determining a predetermined suspected program or any application program to be the target application program.

13. The device according to claim 12, wherein the target application program is configured for analyzing the parameter of the target system call of the application software and determining the application program with the parameter to call private information or a private event to be the target application program when the application program is installed.

14. The device according to claim 13, wherein the private event comprises calling a camera, calling a GPS module, calling a base station positioning user location function, turning on a three-way calling, making a phone call, receiving a phone call, turning on a phone recorder, accessing an address book, accessing a calling history, accessing an SMS message history, intercepting an SMS message, executing silent installation of other programs, automatically transferring network connection data or executing a power-on Autorun; and
the private information comprises at least one of contact information, communication information, photo information or video information.

15. The device according to claim 10, wherein the determining module is configured for judging if the target application program comprises at least one of the predetermined call; if yes, then the target application program with the predetermined call is determined to be the target system call.

16. The device according to claim 10, wherein when a function of the target system call is to send an SMS message, the parameter is an SMS message content or a target phone number;
when the function of the target system call is to connect to a network for the target application program, the parameter is information of a target network to be connected; and
when the function of the target system call is to modify the target application program, the parameter is modifying information from an operator or from a terminal user.

17. A computer readable medium with computer source code having a method for processing an operating application program, and the method comprising steps of:
determining a predetermined suspected program or any application program to be the target application program;
determining the target system call of the target application program when the target application program is initiated;
suspending the target system call when receiving the parameter of the target system call; and
judging if the parameter is the predetermined suspected parameter and decide to continue the target system call.

18. The computer readable medium according to claim 17, wherein if the parameter is the predetermined suspected parameter, the target system call is stopped.

19. The computer readable medium according to claim 17, wherein if the parameter is not the predetermined suspected parameter, the target system call is continued.
